(19) United States
(12) Patent Application Publication
(10) Pub. No.: US 2003/0191731 A1
(43) Pub. Date: Oct. 9, 2003

(54) Method and system for rule based validation prior to committing data to a database system

(75) Inventors: J. Peter Stewart, Boca Raton, FL (US); Roger Hernandez, Boca Raton, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: Daleen Technologies, Inc., Boca Raton, FL (US)

(21) Appl. No.: 10/117,377

(22) Filed: Apr. 4, 2002

(51) Int. Cl. G06F 17/00; G06N 5/02; G06F 7/00; G06F 17/60

(52) U.S. Cl. 706/47; 707/103 Y; 705/1

(57) ABSTRACT

A high performance Rule Engine, capable of handling interactions and dependencies within a system. A system, such as a provisioning system for customer care, contains many pieces of interdependent Data. The Rule Engine uses Rule Objects that only need to know hoe to understand and apply a very specific type of Rule from a Rule set. This minimizes the need to parse and interpret a complex all-purpose Rule language. Each Rule Object can be linked together to form a list of Rules emanating from a Business Rule Coordinator Objects. Moreover, each Rule Object is loaded with a operator, such as a conditional operator, at startup, after which the conditional operator does not need to change and the Rule Object hierarchy can be kept active in memory.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### CROSS REFERENCE TO RELATED APPLICATIONS

Not Applicable

### BACKGROUND OF THE INVENTION

1. Field of the Invention

This invention generally relates to the field of database provisioning and more particularly to a method and system to validate database entries prior to committing entries to a database system.

2. Description of the Related Art

The number of Internet and telecommunication based services continues to grow at a very fast pace. Companies continue to add subscriber services such as voice, message, and data services in both the wired and wireless technologies. Along with the growth in the number of services there has been an attendant growth in the complexity of provisioning such services. Many times customers sign up for services such as caller-ID, voice mail-boxes, three-way calling, call transfer, DSL and other EXPRESS MAIL LABEL NO. EL863783045US services which may have complex interdependencies. For example, in order to start DSL service, the subscriber must have a phone number installed for a certain period of time to determine if the physical line quality is can actually support a DSL class of service.

Providers of services build complex checks and balances into their system to ensure that the required interdependencies are satisfied before another service is added.

One solution is disclosed in U.S. Pat. No. 5,875,440 entitled “Hierarchically Arranged Knowledge Domains” with inventors Marc Cooperman and Robert Karch, which discloses an improved expert system wherein rules are organized into domains and subdomains, and objects are passed to rules to be operated upon. Prior to operating upon any object, the domain determines if the object is of the type which is to be operated upon by rules within the rule domain. If not, the rules are not applied to the object.

Another solution is disclosed in U.S. Pat. No. 5,379,366 entitled “Method for Representation of Knowledge In a Computer As A Network database System” with inventor Noyes R. Dallas which discloses a system for knowledge representation in a computer, together with the ability to recognize, store and use patterns in a knowledge representation system The knowledge representation system defines a novel database engine constituting a method for modeling knowledge as a network of concepts and a plurality of relationships between the concepts comprising the network. Each concept is represented as a record in the database, which is identified by a unique record reference number. The unique record reference numbers are stored within the records comprising the database to record the plurality of relationships between concepts.

These known solutions although useful are not without their shortcomings. One shortcoming is that these systems rely on complex multipurpose rule languages. The whole functionality in a complex multipurpose rule language depends on ability of the parsing engine to understand the language and apply any rule-dictated actions on the data. Accordingly, a need exists for a system and method to overcome this shortcoming and to provide a system for provisioning data into a database without the use of complex multipurpose rule language.

Another shortcoming with these prior art systems is that these interdependent complex checks and balances using multi-purpose rules languages are typically performed as the data is committed to the database. Therefore a customer service representative taking an order via the telephone from a subscriber wishing to add a new subscriber service may not realize while taking the customer order that the service can not be provisioned because of an interdependency. Accordingly, a need exists for a method and system to validate subscriber service requests prior to being committed to the subscriber database.

Still, another shortcoming with these prior art system is that these interdependent complex checks and balances using multi-purpose rule languages are often times very resource dependent because of their size and performance requirements. These prior systems are not resident in memory and therefore cannot ensure fast efficient execution on incoming data. Accordingly, a need exists for a method and system to overcome this shortcoming as well and to provide a system to validate subscribers that can provide high performance by keeping rules in memory.

Yet, still another shortcoming with these prior art systems is that many of these systems require hard coding of rules. The use of hard coded rules makes it expensive in terms of programming resources to make additions, deletions or revisions to the rules. Accordingly, a need exists for a method and system that would minimize hard coding of rules and to provide a table-driven set of rule definitions.

### SUMMARY OF THE INVENTION

Briefly, according to the present invention, disclosed is a method, a system and computer readable medium for small, highly specialized Rule Objects using a small number of select rules and rule language to evaluate the conditions under which a rule should be applied.

The present invention minimizes hard coding of rules because it is table-driven and optimized by using specialized Rule Objects for each type of rule. Disclosed is a high-performance Rule Engine, capable of handling interactions and dependencies within systems that consist of many pieces of interdependent Data, both within individual components and within a hierarchy of components. The performance goal is aided by the use of specialized Rule Objects that only need to know how to understand and apply a very specific type of rule, thus minimizing the need to parse and interpret a complex all-purpose Rule Language. For example, a maximum length Rule only needs to understand how to compare its maximum value with the length of the input.

Moreover, the present invention enables the ability to “chain” multiple Rule Objects, in a linked list of Rules emanating from the Business Rule Coordinator Object (BRCO), allows the Property to have several Rules of each type. The Rules in the chain can be based on different conditions, e.g. various circumstances under which the Property becomes read-only or mandatory.

Each Rule Object is loaded with its condition, expressed in a simple Rule language, and other Rule Data at startup, after which this Data never changes.

In one embodiment, the invention is used in a system for provisioning Data such as a customer care system or Billing System. Described is a system, a computer program product and method for creating a Rule Engine for applying Rules to Data within a system, wherein the Data is interdependent Data both within an individual Rule Object and within a hierarchy of Rule Objects. The method includes defining a Business Process Object (BPO); defining one or more BRCOs; associating the one or more BRCOs with a BPO; instantiating one or more Rule Objects inheriting from a single base class to form a hierarchical network of Rule Objects for a given one of the one or more BRCOs; wherein each of the Rule Objects includes one or more Inputs and zero or more Outputs and zero or more conditional operators defined by Data in the Database; wherein each of the zero or more conditional operators uses zero or more pieces of Data read from the Database as specified by each of the Rule Objects.

Furthermore, the Rule Engine in this embodiment includes executing each of the one or more Rule Objects so each of the conditional operators returns a result of an operation on Data specified by each of the Rule Objects to one of the given one of the one or more BRCOs.

### BRIEF DESCRIPTION OF THE DRAWINGS

The subject matter, which is regarded as the invention, is particularly pointed out and distinctly claimed in the claims at the conclusion of the specification. The features, and advantages of the invention will be apparent from the following detailed description taken in conjunction with the accompanying drawings. Additionally, the left-most digit of a reference number identifies the drawing in which the reference number first appears.

FIG. 1 is a block diagram of a typical customer care provisioning system using a table driven Database, according to the present invention.

FIG. 2 is a diagram of the hierarchy for the business Rules compliance component, according to the present invention.

FIG. 3 is a Class diagram showing the relationship between Data and Business Rule Objects, according to the present invention.

FIG. 4 is a Class diagram of FIG. 3 further defining the relationship between the Data hierarchy including services, features and parameters and the Business Rule Object, according to the present invention.

FIG. 5 is an exemplary process flow for changing a Subscriber from non-billable to billable using the Class diagram of FIGS. 3 and 4, according to the present invention.

FIG. 6 is a collaborative diagram, illustrating the flow sequence of FIG. 5 carried out by each object of FIGS. 3 and 4, according to the present invention.

FIG. 7 is an exemplary flow chart of illustrating the formation of the Rules hierarchy of multiple Rules emanating from a Business Rules Coordinator Object, according to the present invention.

### DETAILED DESCRIPTION OF AN EMBODIMENT

It is important to note, that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

In the drawing like numerals refer to like parts through several views. Capitalized terms used in these descriptions are defined in the Glossary found at the end of this section.

Customer Care Provisioning System

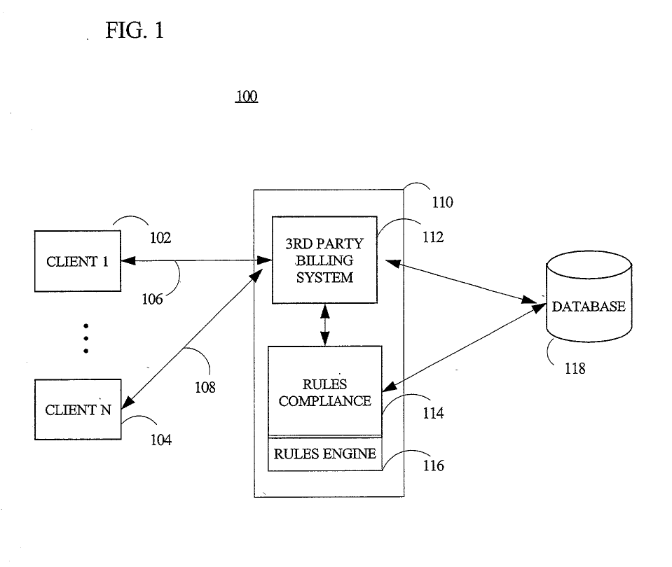

Turning to FIG. 1, shown is a block diagram 100 of a typical customer care provisioning system using a table driven Database according to the present invention. One or more customer care representatives using a clients 102 and 104 over a wired or wireless public or private network 106 and 108 communicate with a Billing System 110. As shown, the Billing System 110 has two major components. The first major component is a third party Billing System 112 such as BILLPLEX from Daleen Technologies in Boca Raton or Portal Software, Inc. The second major component is a Rules compliance component 114, which is in communications with the Billing System 112. It should be understood that the component Business Rules Compliance Component 114 does not have be constructed as a stand alone component and can be integrated directly into the Billing System 112 and/or Database 118 system. The component Business Rules Compliance Component 114 includes a Rules Engine 116 for executing Rule as further described below. The Database 118 system is any relational database such as Oracle, IBM DB2, or equivalent.

Business Rule Compliance Component

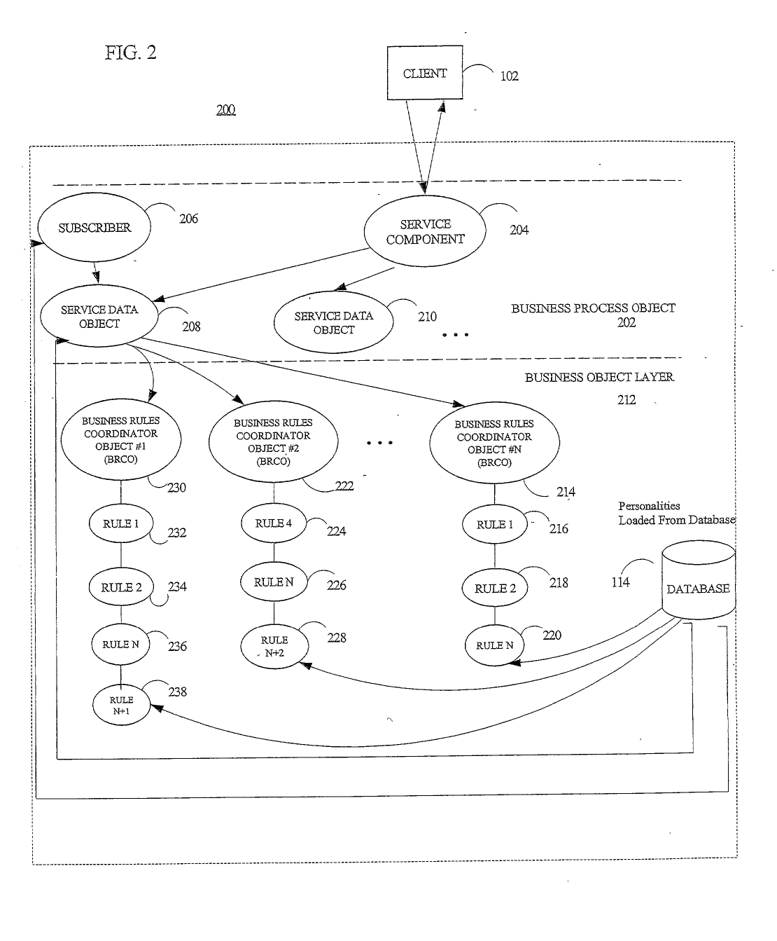

FIG. 2 is a diagram 200 of the hierarchy for the business Rules compliance component 114, according to the present invention. There are two layers in the component Business Rules Compliance 114. The first layer is the Business Process Object 202. This layer includes a Server Component 204, which provides the program functionality for interfacing with the client for customer provisioning 102. In addition, the Service Component 204 calls a Service Data Object 208, 210 which instantiates one or more Business Rules Coordinator Objects (BRCOs) 214, 222, 230. For example, if the service being provisioned is a caller-id, the Service Component 204 calls the appropriate Service Data Object 208 or 210. In this case a Service Data Object 208 for caller-id is called and the information on the Subscriber 206 is passed along. It is important to note that the information on the Subscriber 206 is pulled from the Database 114.

The second layer in the business Rules compliance component 114 is the Business Object Layer 212. The Business Object layer 212 consists of one or more BRCOs 214, 222, 230 that are instantiated from the services Data Object 208. Each BRCO 214, 222, 230 contains one or more Rule Objects 216, 218, 220, 224, 226,228, 232, 234, 236, 238. It is important to note that the Business Object layer 212 forms a separate layer, loaded and initialized at startup. This layer is fully reentrant and can be used by any number of threads simultaneously.

Apart from the Rule Data, which does not change while the program is running, no other state information is maintained inside this Business Object Layer 212. Any Rule Object that has one or more states is passed in on each call, and any state will only last for the duration of that single call to the Rule Engine 116. Accordingly, another thread accessing the same Rule Objects at the same time will have a different set of state information, maintained in the context of the thread.

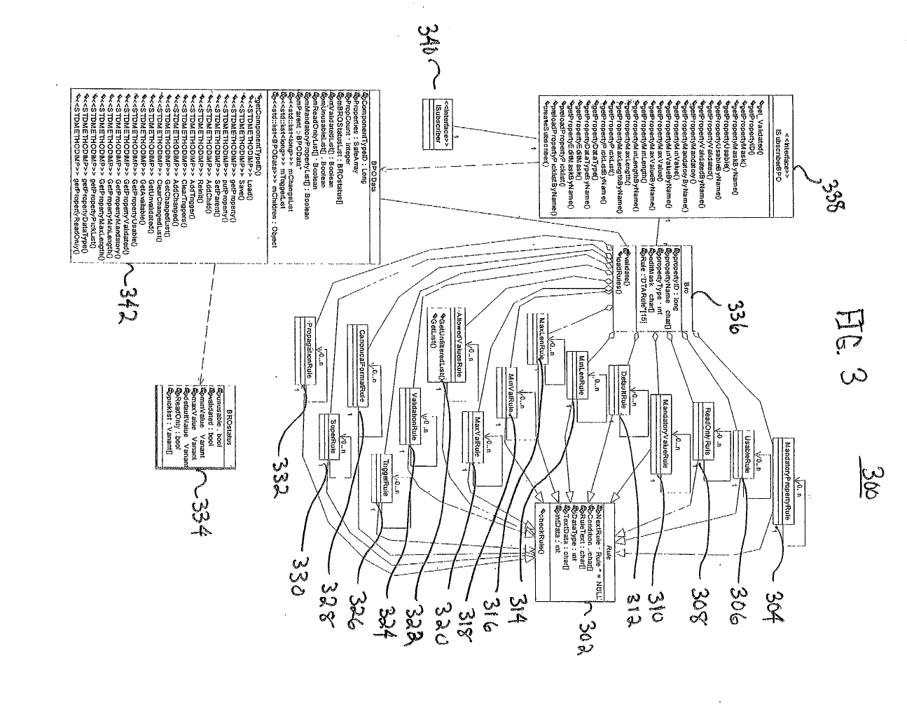

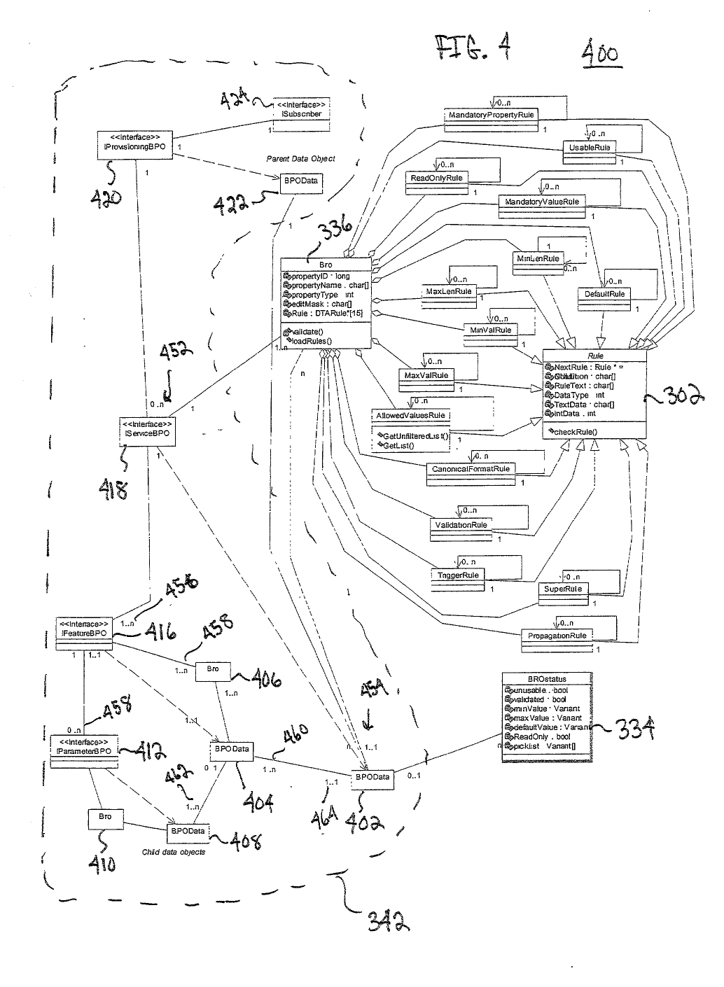

All Rule Objects 216, 218, 220, 224, 226, 228, 232, 234, 236, 238 are derived from the same base Class and have the same interface as illustrated in FIGS. 3 and 4 below. Similarly all BRCOs 214, 222, 230 are instantiated from the same Class and are all the same Object—the only difference lies in how they have been associated with a specific Property and initialized with the Rules for that Property.

The Rule Engine 116 executes one of the types of the specialized Rule Objects. These types include usability, read-only, default value, mandatory property, mandatory value, minimum value, maximum value, minimum input length, maximum input length, allowed values list, canonical format, trigger/notification, propagation, and “super-rule”. The “super-rule” type allows hard coding of specific complex actions, while still using the Rule Engine to evaluate the conditions for imposing the Rule and also allowing it to be table-driven. These Rule types are further described in the Rule Language Definition section below.

The components that use the Rule Engine 116 each instantiate a Data Object as part of the Service Data Object 208 that holds both the current value of each Property and the current state of the Property, i.e. valid/invalid, read-only, mandatory, and more. On each call to the BRCO for a Property, a pointer to this Data Object is passed in.

The Data Objects are organized in a hierarchy, where each parent Object holds a list of its children and each child Object knows its own parent. When a Rule Object needs to know the current value of a Property, it calls its associated Data Object using a Property and component ID. If the Data Object does not hold that Property, it will request it from its immediate parent. The parent Data Object may do the same thing, if it does not recognize the component ID as its own. If a top-level Data Object, without a parent, is reached and the component ID is still not recognized, an error will be returned to the caller.

Class Diagram of the Relationship Between Data and Business Rule Objects

FIG. 3 is Class diagram 300 shown is a relationship between Data and Business Rule Objects, according to the present invention. A base Rule Class 302 is shown. Each of the Rule Object types 304, 306, 308, 310, 312, 314, 316, 318, 320, 322, 324, 326, 328, 330, 332 are described in further detail below in the section entitled “Rule Definition Language”. The BRCO 336 contains one or more Rule Objects types 304, 306, 308, 310, 312, 314, 316, 318, 320, 322, 324, 326, 328, 330, 332. The BRCO 336 is instantiated through an interface 340 for Subscriber Object 338 with a Service Component 204 along with a pointer to the Data 342. Therefore each Rule Object type does not have a state but rather works on Data that is passed to it. A status for the Data 324 is returned Object 334.

FIG. 4 is a Class diagram 400 of FIG. 3 further defining the relationship between the Data 342 hierarchy including services, features and parameters and the Business Rule Object 336, according to the present invention. The Provisioning Object 420. The Provisioning Object 420 holds zero to N Service Objects 418 as denoted by the schema notation 452 0-n and the top level connection to the Subscriber Object 424 along with the parent Data Object 422 in which these subscriber services need. The parent Data Object is associated 454 with Business Process Data 402.

The Service Object 418 has one or more Data Objects 402 as denoted by notation 454, one or more Feature Objects 416 as denoted by notation 456 zero to N Parameter Objects 412 P as denoted by 458 and (Business Rules Object) BRO 410.

The Feature Object 416 has one or more Business Rules Object 406 as denoted by 458. Each Business Process Object 406 has a hierarchy of Data Objects denoted in FIG. 3 as 342 and in FIG. 4 as 404, 408 and 402 depending on the specific Rules in the Business Rules Object 406 with pointers to each other 460, 462, 464. This is important since all of the Data and Rules are loaded upon from the Database 114 upon instantiation. Stated differently, the Data 342 Object are organized in a hierarchy, where each parent Object holds a list of its children and each child Object knows its own parent. When a Rule Object needs to know the current value of a Property, it calls its associated Data Object using a Property and component ID. If the Data Object does not hold that Property, it will request it from its immediate parent. The parent Data Object may do the same thing, if it does not recognize the component ID as its own. If a top-level Data Object, without a parent, is reached and the component ID is still not recognized, an error will be returned to the caller in Object 334. For example, the Data Object 408 for the Parameter Business Process Object 412, can link to the feature Data Object 404 to get any Data that it requires and if the Data is not found at the Data Object 404, the Data Object 404 can call the Data Object 402 for the Service and if the Data required is still not required it can go up to Data Object 422 to retrieve the Data as necessary. This show how each major Subscriber Object 338 has it own Data Object 342 and its own set of Rule Objects 336. Business Object business. For the Service Object 338 the Rule Object 336 is expanded.

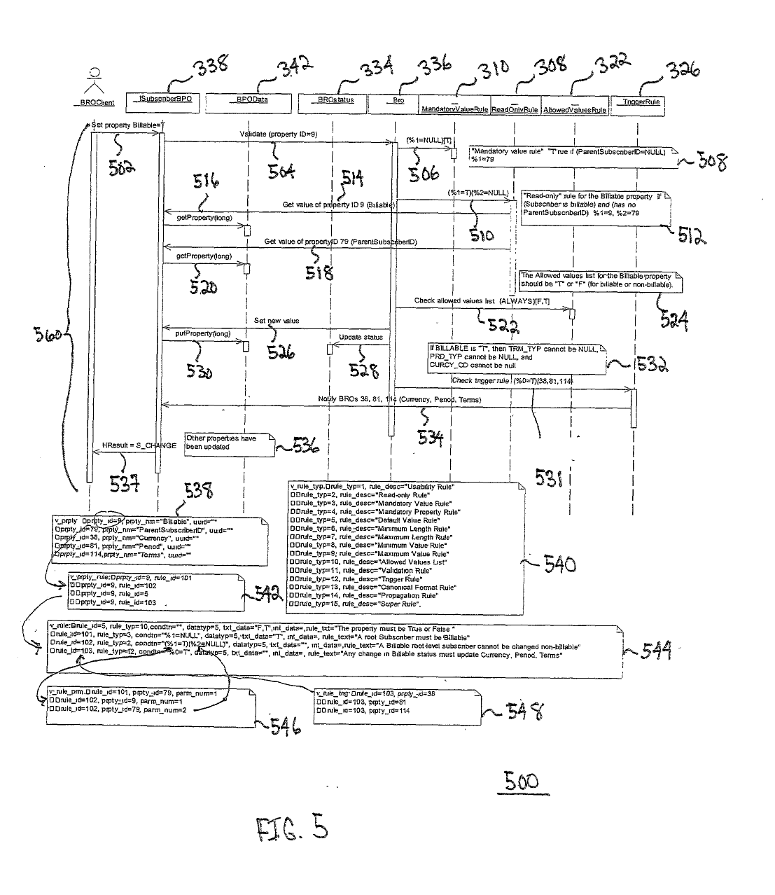

FIG. 5 is an exemplary process flow 500 for changing a Subscriber from non-billable to billable using the Class diagram of FIGS. 3 and 4, according to the present invention. Illustrated across the top are the Objects 338, 342, 334, 336, 310, 308, 322, 326, which are the process flow uses for this example. The flow begins in the upper left hand corner and ends in the lower left hand corner through the interface to the Subscriber Object 338. This sequence diagram is divided into three sections: (i) the Objects 338, 342, 334, 336, 310, 308, 322 and 326; (ii) the Flow shown in the middle section 560 which is being processed by the Objects; and (iii) the Data 538, 540, 542, 544, 546, 548 loaded from the Database 114 for the Rule Objects 336 and all its associated Rule objects 304-332. The process begins with a client 102 setting a property to be billable (property Billable=T) for a validation, step 502 using interface Subscriber Object 338. This is one example of many properties that can be validated. A Business Rule Object 336 is called which applies a Business Rule Object 336, mandatory value Rule 310., in step 506. We stop at this point to explain how the Data loaded is being associated with the flow 560. The Validate step 504 has an ID=9 property as show. This is used as an index into v_prpty table 538 and it retrieves the first line: prpty_id=9, prpty_nm=“Billable”, uuid=″”.

In turn, the prpty_id =9 in v_prpty_rule table 538 indexes four entries in table 542 for the underlying Rules. Each of these entries in table 542 is associated with Rules in v_rules table 544 by a rule_id (number 101, 102, 5, and 103) in this example v_prpty_rule table 542. Each rule_id (number 101, 102, 5, and 103) corresponds to a rule in v_rule 544 table. Each entry in the v_rule table 544 pulls in a v_rule_pm 546 and v_rule_trig 548. In addition in the v_rule table 544, each row has a rule_type which is pulled in from v_rule_type table 540. For example the second row of v_rule table 544 has: rule_id=101, rule typ=3. And rule type=3 in the v_rule_typ table 540 corresponds to the “Mandatory Value Rule”. The variable %1 in the second row of v_rule table 544 has: rule_id=101, ruletyp=3, condtn %1=NULL where variable %1 is pulled in from the v_rule_prm table 546 first row corresponding to rule_id=101 with prpty_id=79 substitute for %1 much as done in DOS batch files to those familiar with the art.

Now described is the process for loading the “personalities” or Rules and pointers to Data for the Business Rules Object 336. It is important to note that the Rules once loaded do not change but that the Data is loaded from the Database when the Rule is executed to ensure that the most current Data is evaluated. Continuing further since the Business Rules Object 336 has one or more rules associated therewith, we look at this example and determine the form v_prpty table 542 there are four row each with a Rule associated with it: rule id_{—}101, rule_id=102, rule_id=5, and rule_id=103 and the v_rule table 504 using the rule_id as index provides us the following four Rules (in the order shown in v_prpty table 538 and indexing V_rule table 544:

rule_id=101→rule_type=3

rule_id=102→rule_type=2

rule_id=5→rule_type=10

rule_id=103→rule_type=12

where from v_rule_typ table 540, the rule_types index as follows:

rule_type=3→“Mandatory Value Rule” 508

rule_type=2→“Read-only Rule” 512

rule_type=10→“Allowed Values List” 524

rule_type=12→“Trigger Rule” 532

Using this the flows in 560 can now be followed by using the Data table 538, 540, 542, 544, 546 and 548 to determine what Rules and conditions are being tested for the validate property is billable.

In step 532, the trigger Rule causes other Rule objects to be re-validated in this example the “any change in Billable status must update Currency, Period, Terms.”

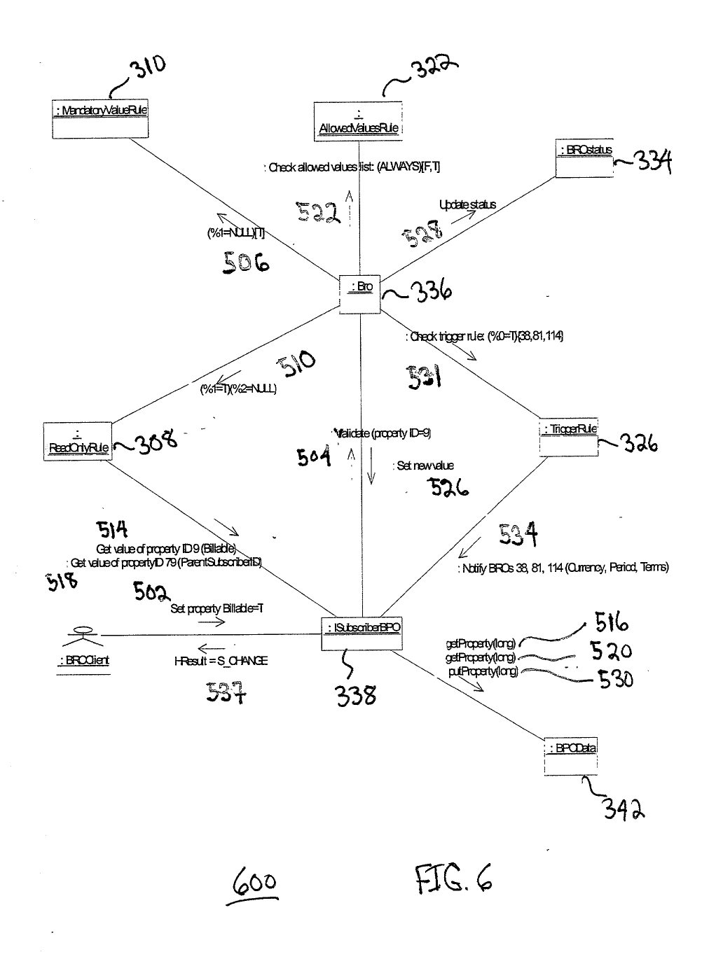

In step 537, the result is returned to the calling application. Steps 510, 514, 516, 518, 520, 522, 526, 528, 530, 531, 534, 536 are sub-processes denoting the interdependencies between a Rules and Data as is shown in FIG. 6 below for demonstrating an exemplary process of changing a Subscriber from non-billable to billable. Steps 510, 514, 516, 518, 520, 522, 526, 528, 530, 531, 534, 536 retrieve the current value of properties as needed to evaluate and apply rules.

FIG. 6 is a collaborative diagram, illustrating the flow 560 sequence of FIG. 5 carried out by each object of FIGS. 3 and 4, according to the present invention. Each of the steps in collaborative diagram shows the interdependencies of Data within a Rule. More specifically each of the steps n FIG. 6 corresponds directly and FIG. 6 is an alternate view of the collaboration and those of average skill in the art understand interdepencies occurring in FIG. 5.

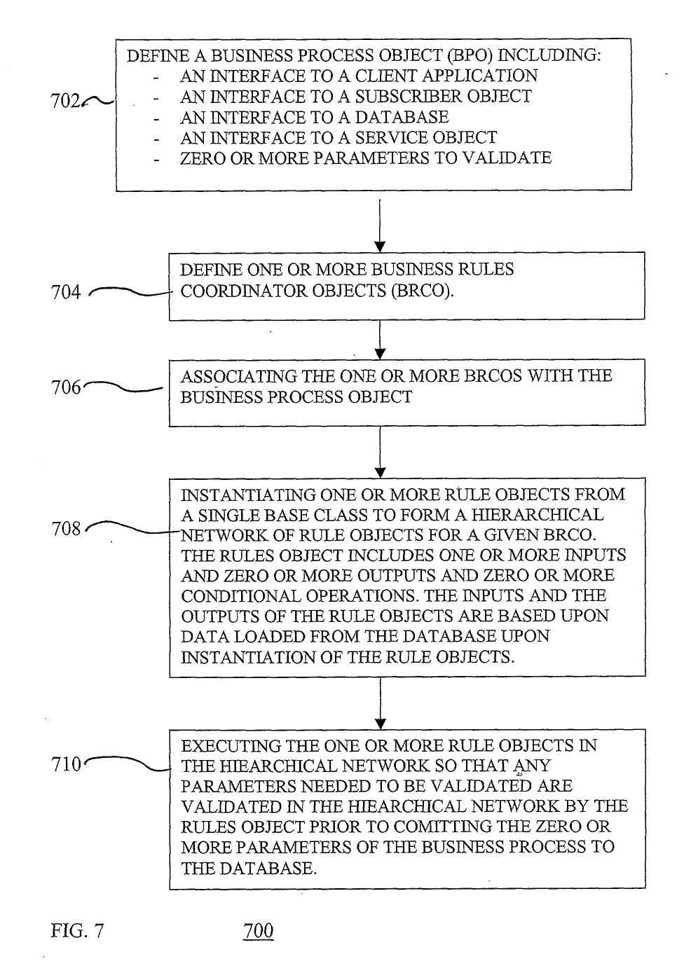

FIG. 7 is an exemplary flow chart 700 of illustrating the formation of the Rules hierarchy of multiple Rules emanating from a Business Rules Coordinator Objects, according to the present invention. Referring to FIG. 2, the process begins in step 702, with a Business Process Object 202 being defined with an interface to Database 114, an interface to a Subscriber Object 206; and interface to a Service Data Object 208; and zero or more Parameters to Validate.

Next, in step 704, one or more Business Rule Coordinator Objects (BRCOs_230-214 are defined and associated with the Business Process Object 202 in step 706. The instantiating of one or more Rule Objects 232-238 and 222-228 and 216-220 are next performed for each BRCOs 230, 222, and 214 respectively. Each of the Business Rule Objects has one or more inputs, zero or more outputs and zero or more conditional operators. The Data is loaded from the Database upon instantiation of the Rule Objects. The Rule Objects are executed in a hierarchical network so that any parameters need to be validated are validated in the hierarchical network prior to being committed to the Database, in step 710. It is important to note that the Data used as parameters from the Database is accessed via pointers so that when one or more Rule Objects accessed Data, which are parameters from the Database, any updates or revisions to the Data are available to all Rule Objects simultaneously. Moreover, once the Data, which represents operators, such as conditional operators are loaded during the instantiation of the Rule Objects, none of the conditional parameters are changed. As a result and as understood by those of average skill in the art, the Rule Objects with the conditional operators once instantiated can be kept in memory and the Data representing parameters can be pulled from the Database during executions. This provides a high-performance Rules engine, capable of handling interaction and dependencies.

Rule Language Definition

The following Rule definition types are described using the basic structure below. As stated above in FIGS. 3 and 4, these types include usability, read-only, default value, mandatory property, mandatory value, minimum value, maximum value, minimum input length, maximum input length, allowed values list, canonical format, trigger/notification, propagation, and “super-rule”. The “super-rule” type allows hard coding of specific complex actions, while still using the Rule Engine to evaluate the conditions for imposing the Rule and also allowing it to be table-driven. These Rule types are further described below.

The formal Rule language is quite straight forward, consisting of parameters, comparisons, constant values, and a few keywords.

Parameters: %1, %2, %3, %4, %5, and %0. The parameter tokens %1-%5 are mapped to the current value of other properties of the current or another component, using the table v_rule_prm. The parameter %0 _refers to the new value of the property that the Rule concerns. To refer to the old value of the property, a parameter should be mapped to the componetlD and propertylD of the property in question.

Comparison operators: ==, <, >, !=(equal to, less than, greater than, not equal to).

The syntax for constants depends on the Data type. Examples: T, F (Boolean), 10, 1000 (Long Integer), 100.00 (Float), “Individual” (String).

Keywords:

ALWAYS—this Rule should be applied unconditionally.

BATCH—in batch mode only.

CREATE—on create only.

EDIT—on edit only.

NOBATCH—only when not in batch mode.

NULL—used in comparisons

TODAY—today's date, used in comparisons.

TRIG—only when triggered by a change in another property.

A condition must always evaluate to a Boolean TRUE for an action to be taken. If multiple conditions are used, then each one must be enclosed in a set of parenthesis, separated by “&&” for a logical AND, or “∥” for a logical OR. AND (&&) means that both/all of the conditions must evaluate to TRUE for the Rule to be applied.

OR (∥) means that one of the conditions must evaluate to true for the Rule to be applied.

### EXAMPLE

(EDIT)&&(%1=T)—which means: in edit mode only, if parameter 1 (e.g. Billable) equals T(rue).

If a query is used as a condition, it will be evaluated as TRUE if the query returns a result set. To reverse the evaluation, prefix the query with a “!”.

In general, the Rules work by evaluating a condition, and if the condition is TRUE, then the Rule Data (text Data or integer Data) is applied depending on the Rule type. Some examples:

| Rule | | Rule | |
|---|---|---|---|
| Type | Condition | Data | Explanation |
| Mandatory | (% 1 = T) | | Mandatory if parameter 1 |
| | | | Property is True |
| | | | (e.g. Subscriber is Billable) |
| Mandatory | (% 1 < 1)∥ | T | Property must be True if |
| | | | Subscriber is Billable |
| value | (% 1 == % 2) | | (Compares SubID and |
| | | | BillableParentID) |
| Max Length | ALWAYS | 80 | Max. length of field is |
| | | | always 80. |

Discussion of Hardware and software Implementation Options

The present invention as would be known to one of ordinary skill in the art could be produced in hardware or software, or in a combination of hardware and software. However in one embodiment the invention is implemented in software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read Data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

Glossary of Terms Used in This Disclosure

Billing System—a system used to calculate charges and request payment from a subscriber or a subscriber's account such as a credit card. Modern Billing Systems also perform may other diversified activities such as service provisioning, credit checks, contract tracking and more. They also hold a wide variety of Data such as detailed Subscriber Information, Service Information for each Subscriber, account comments and subscriber demographic information.

Business Process Object (BPO)—an Object for interfacing with a specific business process or function. Each Business Process Object has a hierarchy of Data Objects and depending on the specific Rules in the Business Rules Object with pointers to each other. This is important since all of the Data and Rules are loaded upon from the Database upon instantiation.

Business Rules Coordinator Object (BRCO)—a fully reentrant Object containing one or more Business Rule Objects.

Business Rule Class—a Class used to communicate with the Database that uses Rules Object to validate changes to Data prior to committing these changes to Data to the Database.

Business Rule Object—(BRO) an instance of a Business Rule Class

Class—In object-oriented programming, a Class is a template definition of the methods and variables in a particular kind of Object. Thus, an Object is a specific instance of a Class; it contains real values instead of variables. The Class is one of the defining ideas of object-oriented programming. Among the important ideas about Classes are: A Class can have subclasses that can inherit all or some of the characteristics of the Class. In relation to each subclass, the Class becomes the superclass. Subclasses can also define their own methods and variables that are not part of their superclass. The structure of a Class and its subclasses is called the Class hierarchy.

Component—a group of one or more Objects like MS Com, like issuing API to all functionality of MS Word.

Data—any information used by a method and procedure in an Object;

Data Object—an Object for holding Data and the current state of any Property. Current state of a Property include valid/invalid, read-only, mandatory, and more. The Data Objects are organized in a hierarchy, where each parent Object holds a list of its children and each child Object knows its own parent. When a Rule Object needs to know the current value of a Property, it calls its associated Data Object using a Poperty and Component ID. If the Data Object does not hold that Property, it will request it from its immediate parent. The parent Data Object may do the same thing, if it does not recognize the Component ID as its own. If a top-level Data Object, without a parent, is reached and the Component ID is still not recognized, an error will be returned to the caller.

Database—A Database is a collection of Data that is organized so that its contents can easily be accessed, managed, and updated. The most prevalent type of Database is the relational Database, a tabular Database in which Data is defined so that it can be reorganized and accessed in a number of different ways.

Input—Data received by an Object.

Object—In object-oriented programming, an Object is an instance of a particular Class or subclass with the Class's own methods or procedures and Data variables.

Output—Data transferred from an Object.

Parameter—variables used in the Rule Language by a Rule Object that are mapped to one or more Properties.

Property—Data that an Object exposes to the outside procedure, functions and Objects and is used to restrict an action in an Object

Rule—one or more arithmetic, Boolean, and conditional operations used in a Rule Language.

Rule Data—Data in a Rule that does not change.

Rule Engine—a set of software routines for applying Rule Language to specific instances of Data and internal relationships within the Data set.

Rule Language—language for expressing one or more conditions for a predefined Rule set which uses a minimum numbers of Rules to avoid complex parsing and interpretation of a generic or all-purpose Rule set. As an example, a maximum length Rule only needs to compare its own Rule Data, in this example the maximum value, with the length of the input in a Rule Object

Rule Object—A programming Object containing Input, Output and Data that evaluate a condition using a Rule Language and perform an action to a Business Rule Coordinator Object.

Service—any item including a good, service, money or the movement thereof, that a Subscriber may use. One Class of Service is communication services, such as POTs (Plain Old Telephone Service) line, cable line, cellular line, satellite, T1 or TCP/IP connection or equivalent. Another Class of Service is utilities such as gas, oil, electric, water, sewer purchased by a Subscriber. Still, another Class of Service is transportation such as ticketing, tolls, freight charges, and shipping charges.

Subscriber—an individual or company that is uniquely identified within the Billing System as a user of services. This could be a cellular phone subscriber, a user of Internet Services or other service user.

Subscriber Information—Subscriber specific Data including a Rate Plan, usage, length, usage type, plan type and other information a provider of services would use to calculate charges for a Subscriber.

Validate—a process of applying one or more Rules in a Rule Language to a given set of Data.

Non-Limiting Examples

It should be understood that the present invention consists of the combination of the following elements:

1. Simple, specialized Rule Objects that essentially only know how to evaluate a condition (using a simple Rule language) and apply some action to the Property to which they have been attached.

2. The Rule Objects are attached to Business Rule coordinator Objects belonging to each Property (piece of user Data) in the system.

3. A mechanism for triggering updates in other properties by simply causing them to revalidate themselves whenever there has been a change in another Property.

4. The current state of each Property is held by Data Objects instantiated by the calling components and passed in to the Rule Engine on each call.

Through use of this invention, Subscriber Services are validated prior to going into a Database. The present invention takes Rules and Data out of a table-driven Database and forming a hierarchical network of Rule Objects, which are populate from tables in the Database and form a hierarchical relationship so that a customer-provisioning request is validated prior to being committed in a Database. This saves time, money and back-end processing. The present invention solves the problem such as validating prior to committing to a Database that a customer Service such as three-way calling, caller-ID, call forwarding cannot be activated until after the phone line is turned on.

It is important to note that although, the present invention is described in terms of a BRCOs and BPOs, that these objects are not limited to “business” processes only. Other processes in systems that use hierarchical or non-hierarchical data that can be processed according to the interdependent rules are within the true scope and spirit of the present invention. Those of average skill in the art understand how a BRCO can be a Rule Coordinator Object in another context and BPO can be a processes object in another context.

Although a specific embodiment of the invention has been disclosed. It will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method for applying Rules to Data for provisioning Data in a Database system, the method comprising:
defining one or more Business Rules Coordinator Objects (BRCOs);
defining a Business Process Object (BPO) containing one or more BRCOs and at least one Data Object and an interface to a Database to hold Data; and
instantiating one or more Rule Objects inheriting from a single base class;
wherein each of the Rule Objects includes one or more Inputs and zero or more Outputs and zero or more conditional operators defined by Data in the Database; and
wherein each of the zero or more conditional operators uses zero or more pieces of Data read from the Database as specified by each of the Rule Objects.

2. The method according to claim 1, wherein instantiating one or more Rule Objects includes instantiating one or more Rule Objects that are completely reentrant and without a stored state therein.

3. The method according to claim 2, wherein instantiating further comprises forming a hierarchical relationship between two or more Rule Objects for each of the BRCOs, wherein the hierarchical relationship is formed using a pointer between each of the two or more Rule Objects.

4. The method according to claim 3, wherein the hierarchical relationship is formed as a linked list of pointers between each of the two or more Rule Objects so as to form a list of Rules emanating from each of the BRCOs.

5. The method according to claim 3, further comprising:
executing each of the Rule Objects so each of the conditional operators returns a result of an operation on Data specified by each of the Rule Objects to one of the BRCOs.

6. The method according to claim 5, wherein the result of an operation on Data is used by each of the BRCOs to notify the BPO of one of the following:
all the operations return a result representing the conditional operators on the Data are true; or
at least one of the of one of the operations return a result representing the conditional operators on the Data are not true.

7. The method according to claim 5, wherein executing the functionality of each of the Rule Objects includes executing the functionality of each of the Rule Object using pointers to Data specified by each of the Rule Objects to Data so that the Data being executed by the zero or more conditional operators is Data which is accessible to other Rule Objects simultaneously and when the zero or more pieces of Data are revised in memory or in the Database the Data which has been revised is available to each of the Rule Objects simultaneously as well.

8. The method according to claim 7, wherein the Rule Objects includes zero to more conditional operators which are selected from a group of conditional operators which has less than twenty types of Rules in a given Rule set of Rules.

9. A method for creating a Rule Engine for applying Rules to Data within a system, wherein the Data is interdependent Data both within an individual Rule Object and within a hierarchy of Rule Objects, the method comprising:
defining a Business Process Object (BPO) containing:
an interface to a Client Application;
an interface to a Subscriber Object;
an interface to a Database;
an interface to a Service Data Object; and
zero or more Parameters to Validate;
defining one or more BRCOs;
associating the one or more BRCOs with a BPO; and
instantiating one or more Rule Objects inheriting from a single base class to form a hierarchical network of Rule Object for a given one of the one or more BRCOs;
wherein each of the Rule Objects includes one or more Inputs and zero or more Outputs and zero or more conditional operators defined by Data in the Database; and
wherein each of the zero or more conditional operators uses zero or more pieces of Data read from the Database as specified by each of the Rule Objects.

10. The method according to claim 9, further comprising:
executing each of the one or more Rule Objects so each of the conditional operators returns a result of an operation on Data specified by each of the Rule Objects to one of the given one of the one or more BRCOs.

11. A computer readable medium containing programming instructions for applying Rules to Data for provisioning Data in a Database system, the programming instructions comprising:
defining one or more Business Rules Coordinator Objects (BRCOs);
defining a Business Process Object (BPO) containing one or more BRCOs and at least one Data Object and an interface to a Database to hold Data; and
instantiating one or more Rule Objects inheriting from a single base class;
wherein each of the Rule Objects includes one or more Inputs and zero or more Outputs and zero or more conditional operators defined by Data in the Database; and
wherein each of the zero or more conditional operators uses zero or more pieces of Data read from the Database as specified by each of the Rule Objects.

12. The computer readable medium according to claim 11, wherein the instantiating one or more Rule Objects includes instantiating one or more Rule Objects that are completely reentrant and without a stored state therein.

13. The computer readable medium according to claim 12, wherein the instantiating further comprises forming a hierarchical relationship between two or more Rule Objects for each of the BRCOs, wherein the hierarchical relationship is formed using a pointer between each of the two or more Rule Objects.

14. The computer readable medium according to claim 13, wherein the hierarchical relationship is formed as a linked list of pointers between each of the two or more Rule Objects so as to form a list of Rules emanating from each of the BRCOs.

15. The computer readable medium according to claim 13, further comprising:
executing each of the Rule Objects so each of the conditional operators returns a result of an operation on Data specified by each of the Rule Objects to one of the BRCOs.

16. The computer readable medium according to claim 15, wherein the result of an operation on Data is used by each of the BRCOs to notify the BPO of one of the following:
all the operations return a result representing the conditional operators on the Data are true; or
at least one of the of one of the operations return a result representing the conditional operators on the Data are not true.

17. The computer readable medium according to claim 15, wherein the executing the functionality of each of the Rule Objects includes executing the functionality of each of the Rule Object using pointers to Data specified by each of the Rule Objects to Data so that the Data being executed by the zero or more conditional operators is Data which is accessible to other Rule Objects simultaneously and when the zero or more pieces of Data are revised in memory or in the Database the Data which has been revised is available to each of the Rule Objects simultaneously as well.

18. The computer readable medium according to claim 17, wherein the Rule Objects includes zero to more conditional operators which are selected from a group of conditional operators which has less than twenty types of Rules in a given Rule set of Rules.

19. A Rule Engine for applying Rules to Data within a system, wherein the Data is interdependent Data both within an individual Rule Object and within a hierarchy of Rule Objects, the rule engine comprising:
a Business Process Object (BPO) containing:
an interface to a Client Application;
an interface to a Subscriber Object;
an interface to a Database;
an interface to a Service Data Object; and
zero or more Parameters to Validate;
one or more BRCOs;
means for associating the one or more BRCOs with a BPO; and
means for instantiating one or more Rule Objects inheriting from a single base class to form a hierarchical network of Rule Object for a given one of the one or more BRCOs;
wherein each of the Rule Objects includes one or more Inputs and zero or more Outputs and zero or more conditional operators defined by Data in the Database; and
wherein each of the zero or more conditional operators uses zero or more pieces of Data read from the Database as specified by each of the Rule Objects.

20. The Rule Engine according to claim 19, further comprising:
means for executing each of the one or more Rule Objects so each of the conditional operators returns a result of an operation on Data specified by each of the Rule Objects to one of the given one of the one or more BRCOs.
